(19) United States
(12) Patent Application Publication
(10) Pub. No.: US 2026/0351286 A1
(43) Pub. Date: Nov. 5, 2026

(54) VIDEO EDITING METHOD, ELECTRONIC DEVICE AND NON-TRANSITORY COMPUTER-READABLE STORAGE MEDIUM

(71) Applicant: Beijing Zitiao Network Technology Co., Ltd., Beijing (CN)

(72) Inventors: Yiru CHEN, Beijing (CN); Shaojie WANG, Beijing (CN); Yanfei CHEN, Beijing (CN); Jing WANG, Beijing (CN); Yubin YU, Beijing (CN)

(21) Appl. No.: 19/664,952

(22) Filed: Apr. 30, 2026

(30) Foreign Application Priority Data
Apr. 30, 2025 (CN) 2025105717733

(51) Int. Cl. G11B 27/031

(52) U.S. Cl. CPC G11B 27/031

(57) ABSTRACT

Embodiments of the present application provide a video editing method, electronic device and a non-transitory computer-readable storage medium. The method includes: acquiring at least one piece of media content; respectively performing content understanding on the at least one piece of media content to obtain content description information of each piece of media content; determining a video editing link according to the content description information of each piece of media content, where the video editing link includes at least one video editing function and an execution order between each of the at least one video editing function; and performing video editing on the at least one piece of media content through the video editing link to obtain a video editing result corresponding to the at least one piece of media content.

### CROSS-REFERENCE TO RELATED APPLICATION

This application claims the priority to and benefits of the Chinese Patent Application, No. 202510571773.3, which was filed on Apr. 30, 2025. All the aforementioned patent applications are hereby incorporated by reference in their entireties.

### TECHNICAL FIELD

The present application relates to a video editing method, electronic device and a non-transitory computer-readable storage medium.

### BACKGROUND

Under the trend of intelligent multimedia content creation, using a large artificial intelligence (Artificial Intelligence, AI) model for video editing has become a frontier trend in the industry.

### SUMMARY

In view of this, embodiments of the present application provide a video editing, electronic device and a non-transitory computer-readable storage medium.

In order to achieve the above objective, the embodiments of the present application provide the following technical solutions:

In the first aspect, an embodiment of the present application provides a video editing method, including:
acquiring at least one piece of media content;
respectively performing content understanding on the at least one piece of media content to obtain content description information of each piece of media content;
determining a video editing link according to the content description information of each piece of media content, where the video editing link includes at least one video editing function and an execution order between each of the at least one video editing function; and
performing video editing on the at least one piece of media content through the video editing link to obtain a video editing result corresponding to the at least one piece of media content.

In the second aspect, an embodiment of the present application provides a video editing apparatus, including:
a media content acquisition unit, configured to acquire at least one piece of media content;
a media content understanding unit, configured to respectively perform content understanding on the at least one piece of media content to obtain content description information of each piece of media content;
an editing link determination unit, configured to determine a video editing link according to the content description information of each piece of media content, where the video editing link includes at least one video editing function and an execution order between each of the at least one video editing function; and
a video editing unit, configured to perform video editing on the at least one piece of media content through the video editing link to obtain a video editing result corresponding to the at least one piece of media content.

In the third aspect, an embodiment of the present application provides an electronic device, including: a memory and a processor, where the memory is configured to store a computer program, and the processor is configured to, when executing the computer program, cause the electronic device to implement the video editing method according to any one of the above implementations.

In the fourth aspect, an embodiment of the present application provides a computer-readable storage medium storing a computer program, where the computer program, when executed by a computing device, causes the computing device to implement the video editing method according to any one of the above implementations.

In the fifth aspect, an embodiment of the present application provides a computer program product, where the computer program product, when running on a computer, causes the computer to implement the video editing method according to any one of the above implementations.

### BRIEF DESCRIPTION OF DRAWINGS

The drawings herein, which are incorporated into and constitute a part of this specification, illustrate embodiments consistent with the present application and, together with the description, serve to explain the principles of the present application.

In order to more clearly explain the technical solutions in the embodiments of the present application or in the related art, the drawings that need to be called in the description of the embodiments or the prior art will be briefly introduced below. Obviously, for those of ordinary skill in the art, they may also obtain other drawings according to these drawings without paying any creative effort.

FIG. 1 is a flowchart of steps of a video editing method provided by an embodiment of the present application;

FIG. 2 is a first interaction flowchart of a video editing method provided by an embodiment of the present application;

FIG. 3 is a second interaction flowchart of a video editing method provided by an embodiment of the present application;

FIG. 4 is a schematic structural diagram of a video editing apparatus provided by an embodiment of the present application; and

FIG. 5 is a schematic hardware structural diagram of an electronic device provided by an embodiment of the present application.

### DETAILED DESCRIPTION

In order to understand the above objectives, features and advantages of the present application more clearly, the solutions of the present application will be further described below. It should be noted that the embodiments of the present application and the features in the embodiments may be combined with each other without conflict.

Many specific details are set forth in the following description to facilitate a full understanding of the present application, but the present application may also be implemented in other ways different from those described herein. Obviously, the described embodiments are part of the embodiments of the present application, but not all of the embodiments.

In the embodiments of the present application, words such as "exemplary" or "for example" are used to represent examples, illustrations or explanations. Any embodiment or design solution described as "exemplary" or "for example" in the embodiments of the present application should not be construed as more preferable or more advantageous than other embodiments or design solutions. Exactly speaking, the words such as "exemplary" or "for example" are intended to present relevant concepts in a specific way. In addition, in the description of the embodiments of the present application, unless otherwise specified, the meaning of "a plurality of" refers to two or more.

At present, the AI video production function in video editing applications sets up a large number of independent tool entry according to scene dimensions such as daily sharing and product promotion, but users’ creation motivation is not fixed and single. The same user may have diverse needs at different times. The scene-based function splitting requires the user to frequently switch between different independent entry, and the difference in operation logic of each tool further increases the user's cognitive burden. This design is contrary to the original intent of AI technology to lower the use threshold and improve creation efficiency. Users not only need to learn multiple sets of interaction rules, but also suffer from the interruption of the creation process due to the fragmentation of function modules, increasing time costs and operational complexity.

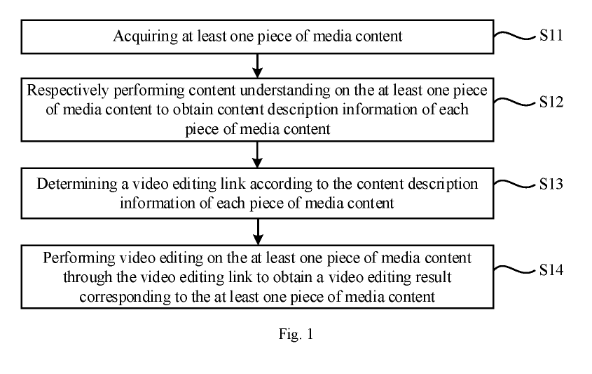

An embodiment of the present application provides a video editing method, and an execution body of the video editing method may be applied to a video editing apparatus. As shown in FIG. 1, the video editing method includes the following steps S11 to S14:

S11, acquiring at least one piece of media content.

The media content in the embodiments of the present application may be any type of media content, such as pictures, videos, audios, texts, animations, etc., and the acquired at least one piece of media content may include multiple pieces of media content of the same type or include multiple types of media content, which is not limited in the embodiments of the present application.

It should be noted that since a video usually has a relatively large data volume, when the at least one piece of media content includes a video, frames may be first extracted from the video, and only a frame extraction result of the video may be used as the media content, so as to reduce data transmission and processing pressure and improve interaction efficiency. The frame extraction from the video may include: extracting representative key frames from the video. For example, frames are extracted from the video at a fixed interval, or extracted based on detection of picture content changes, and video frames whose picture content changes are greater than a preset threshold are extracted.

In some embodiments, the execution body of the video editing method provided by the embodiments of the present application is a client device, and the acquiring at least one piece of media content includes: acquiring the at least one piece of media content in response to a media content selection operation of a user.

In some other embodiments, the execution body of the video editing method provided by the embodiments of the present application is a server, and the acquiring at least one piece of media content includes: receiving the at least one piece of media content sent by a client device.

S12, respectively performing content understanding on the at least one piece of media content to obtain content description information of each piece of media content.

In some embodiments, the respectively performing content understanding on the at least one piece of media content to obtain content description information of each piece of media content includes: respectively inputting the at least one piece of media content into a pre-trained media content understanding model, and acquiring the content description information of each piece of media content output by the media content understanding model.

In some embodiments, the content description information of the media content may include two parts, one part is a key phrase, and the other part is metadata. The key phrase is used to describe the content included in the media, and the metadata is used to represent metadata information of the media content.

Exemplarily, when the media content is an image or a video, the key phrase in the content description information of the media content may be as follows:
detailed description: showing a scene of a woman watching a sunset by the sea. The background is a beautiful sunset, and the sun is slowly setting, the sky presents a gradient color of orange and yellow, the sea is calm and reflects the glory of the sunset. There is a rock on the right side of the picture, and a silhouette of the woman's profile is on the left side;
keywords: sunset, seaside, rock, sunset, woman;
shooting location: AAA;
type: landscape photography, portrait photography, natural landscape.

Exemplarily, when the media content is an image or a video, the metadata in the content description information of the media content may include:
identification number: 12345;
type: video;
ID in the resource server: 12121;
duration: 1200ms;
width: 720;
height: 1080.

S13, determining a video editing link according to the content description information of each piece of media content.

The video editing link includes at least one video editing function and an execution order between each of the at least one video editing function.

The video editing link in the embodiments of the present application refers to an editing process obtained by a series of ordered processing steps and logical combinations from the original media content to the final finished product in the video editing process. Exemplarily, the video editing function may include: super-resolution, noise reduction, editing, effect adding, audio processing, color adjustment, subtitle adding, etc.

In some embodiments, the determining a video editing link according to the content description information of each piece of media content includes: selecting a video editing link matching with the content description information of each piece of media content from video editing links corresponding to pre-configured AI video production functions.

It should be noted that one or more video editing links may be determined according to the content description information of each piece of media content. When multiple video editing links are determined according to the content description information of each piece of media content, video editing may be performed on the at least one piece of media content through the multiple video editing links respectively to obtain multiple video editing results, or one video editing link may be selected from the multiple video editing links to perform video editing on the at least one piece of media content to obtain one video editing result. An implementation of selecting one video editing link from the multiple video editing links may be: selection based on a video editing link selection algorithm or selection by the user.

S14, performing video editing on the at least one piece of media content through the video editing link to obtain a video editing result corresponding to the at least one piece of media content.

When the execution body of the video editing method is a server, the video editing method further includes: sending the video editing result to a client device.

According to the video editing method provided by the embodiments of the present application, after at least one piece of media content is acquired, content understanding is first performed on each piece of media content to obtain content description information of each piece of media content; then a video editing link is determined according to the content description information of each piece of media content, and video editing is performed on the at least one piece of media content through the video editing link to obtain a video editing result corresponding to the at least one piece of media content. Since the video editing method provided by the embodiments of the present application may acquire the content description information of each piece of media content, automatically determine a video editing link according to the content description information of each piece of media content, and perform video editing on the media content through the determined video editing link to obtain a video editing result, the user only needs to select the media content when performing video editing, and does not need to select an AI video production function or learn rules of different AI video production interaction functions. Therefore, the embodiments of the present application may reduce the time cost and operational complexity of video creation.

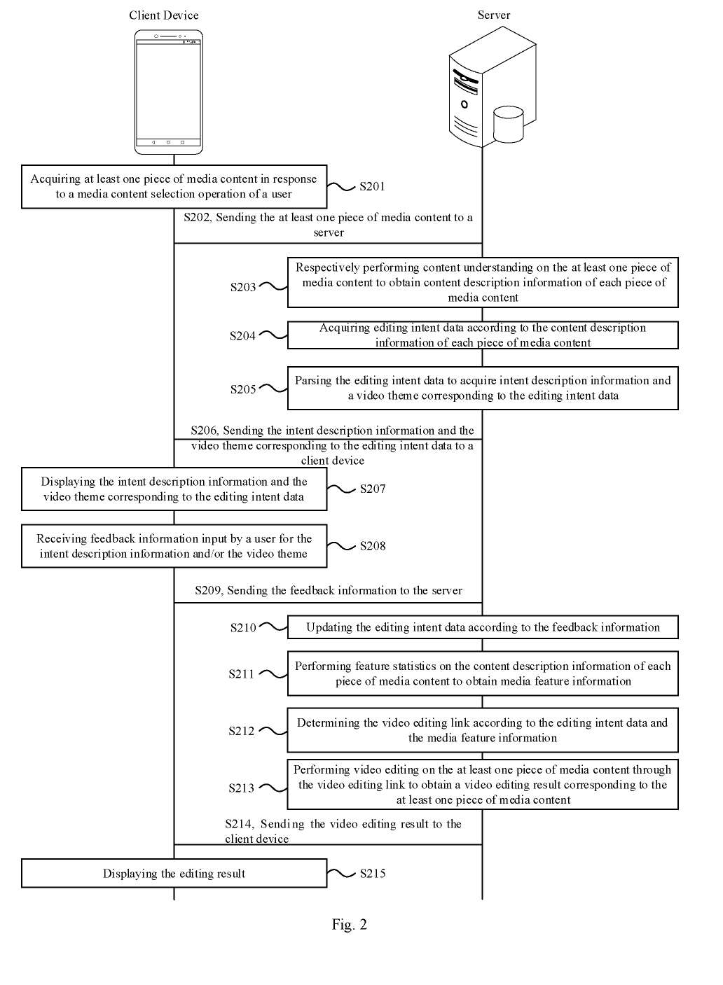

As an extension and refinement of the above embodiments, an embodiment of the present application provides another video editing method. As shown in FIG. 2, the video editing method includes the following steps:

S201, a client device acquires at least one piece of media content in response to a media content selection operation of a user.

In some embodiments, the acquiring, by the client device, at least one piece of media content includes: determining whether the media content selected by the user includes a video file; if not, using each piece of media content selected by the user as the at least one piece of media content; if yes, performing frame extraction on the video file, and using a frame extraction result of the video file and other types of media content selected by the user as the at least one piece of media content.

S202, the client device sends the at least one piece of media content to a server.

Correspondingly, the server receives the at least one piece of media content sent by the client device.

S203, the server respectively performs content understanding on the at least one piece of media content to obtain content description information of each piece of media content.

S204, the server acquires editing intent data according to the content description information of each piece of media content.

It should be noted that the number of editing intent data acquired by the server according to the content description information of each piece of media content may be one or more. When the server acquires multiple pieces of editing intent data according to the content description information of each piece of media content, the subsequent steps may be executed for each editing intent data to obtain multiple video editing results.

In some embodiments, the acquiring, by the server, editing intent data according to the content description information of each piece of media content includes: inputting the content description information of each piece of media content into a pre-trained editing intent prediction model, and acquiring an editing intent data output by the editing intent prediction model.

S205, the server parses the editing intent data to acquire intent description information and a video theme corresponding to the editing intent data.

In some embodiments, the parsing, by the server, the editing intent data to acquire intent description information and a video theme corresponding to the editing intent data includes: respectively inputting the editing intent data into an intent parsing model, and acquiring the intent description information and the video theme corresponding to the editing intent data output by the intent parsing model.

Exemplarily, the intent parsing model may be a large language model (LLM).

The intent description information in the embodiments of the present application may be the user's editing intent data described in natural language. Exemplarily, the intent description information and the video theme corresponding to the editing intent data may be: a spring camping theme, highlighting a relaxed atmosphere of natural scenery and interaction with friends.

S206, the server sends the intent description information and the video theme corresponding to the editing intent data to a client device.

Correspondingly, the client device receives the intent description information and the video theme corresponding to the editing intent data sent by the video editing apparatus.

S207, the client device displays the intent description information and the video theme corresponding to the editing intent data.

S208, the client device receives feedback information input by a user for the intent description information and/or the video theme.

After the client device displays the intent description information and the video theme corresponding to the editing intent data, the user may see the intent description information and the video theme corresponding to each predicted editing intent data. If the intent description information and/or the video theme do not match the user's own editing needs, the user may edit the intent description information and/or the video theme of the editing intent data, and generate feedback information for the intent description information and/or the video theme according to the editing operation.

It should be noted that when there are multiple pieces of editing intent data, the server parses each editing intent data respectively to acquire the intent description information and the video theme corresponding to each editing intent data, and sends the intent description information and the video theme corresponding to all the editing intent data to the client device. The client device also displays the intent description information and the video theme corresponding to each editing intent data, and the user may input feedback information for the intent description information and/or the video theme corresponding to one or more piece of displayed editing intent data.

S209, the client device sends the feedback information to the server.

Correspondingly, the server receives the feedback information sent by the client device.

When there are multiple pieces of editing intent data, identification information corresponding to the multiple pieces of editing intent data may be added to the feedback information, so that the server may determine the editing intent data corresponding to the feedback information according to the identification information.

S210, the server updates the editing intent data according to the feedback information.

It should be noted that, in some embodiments, after updating the target editing intent data according to the feedback information, the video editing apparatus may further return to step S205 to parse the updated target editing intent data, and send the parsed intent description information and video theme to the client device, until the client device sends confirmation information to the video editing apparatus.

In some embodiments, the updating the editing intent data according to the feedback information includes: inputting the content description information of each piece of media content, the editing intent data, and the feedback information into the editing intent prediction model, and acquiring an updated editing intent data output by the editing intent prediction model.

S211, the server performs feature statistics on the content description information of each piece of media content to obtain media feature information.

Exemplarily, the media feature information may include: information such as an average duration, a duration distribution, a total duration, and an average size of each piece of media content in the set of media content.

S212, the server determines the video editing link according to the editing intent data and the media feature information.

In some embodiments, the determining, by the server, the video editing link according to the editing intent data and the media feature information includes: inputting the editing intent data and the media feature information into a pre-trained link routing model, and acquiring a link identification output by the link routing model; and determining the video editing link according to the link identification.

In some embodiments, an implementation of outputting, by the link routing model, the link identification according to the editing intent data and the media feature information may include: determining whether the total duration of the media content is greater than a first threshold duration or less than a second threshold duration; if the total duration of the media content is greater than the first threshold, outputting a link identification corresponding to a first link; if the total duration of the media content is less than the second threshold, outputting a link identification corresponding to a second link; and if the total duration of the media content is greater than or equal to the second threshold duration and less than or equal to the first threshold duration, outputting a link identification corresponding to a link matching with the editing intent data.

S213, the server performs video editing on the at least one piece of media content through the video editing link to obtain a video editing result corresponding to the at least one piece of media content.

S214, the server sends the video editing result to the client device.

Correspondingly, the client device receives the video editing result sent by the server.

It should be noted that, in the embodiments of the present application, an implementation of sending, by the server, the at least one video to the client device may be: the server directly sends the at least one video to the client device through a data transmission link with the client device, or the server may send the at least one video to a resource distribution server, acquire a unique address identifier of each video, and send the unique address identifier of each video to the client, and the client device acquires each video from the resource distribution server according to the unique address identifier of each video.

It should also be noted that when there are multiple video editing links, since time-consuming of video editing by different video editing links is inconsistent, when a video editing link with a short time-consuming acquires a corresponding video editing result, the corresponding video editing result may be immediately sent to the client device, without waiting for all video editing links to acquire corresponding video editing results before sending to the client device.

S215, the client device displays the editing result.

In some embodiments, the editing intent prediction model, the intent parsing model, and the link routing model in the embodiment shown in FIG. 2 may all be models deployed in the server, and the server may call a related model through a model calling interface to implement a related function through the related model.

In some embodiments, at least one of the editing intent prediction model, the intent parsing model, and the link routing model in the embodiment shown in FIG. 2 is a model deployed in another server, and the server interacts with the server deploying the related model to implement a related function through the related model.

In some other embodiments, the editing intent prediction model, the intent parsing model, and the link routing model may also be models deployed in the client device. When the editing intent prediction model, the intent parsing model, and the link routing model are deployed in the client device, the step flow of interacting with the server is no longer required in the embodiment shown in FIG. 2. For example, the client device no longer needs to perform step S202 to send the at least one piece of media content to the server, but the principles and implementations of the client device performing other step flows are similar to the principles and implementations of the server performing each step flow, and are not repeated here to avoid redundancy.

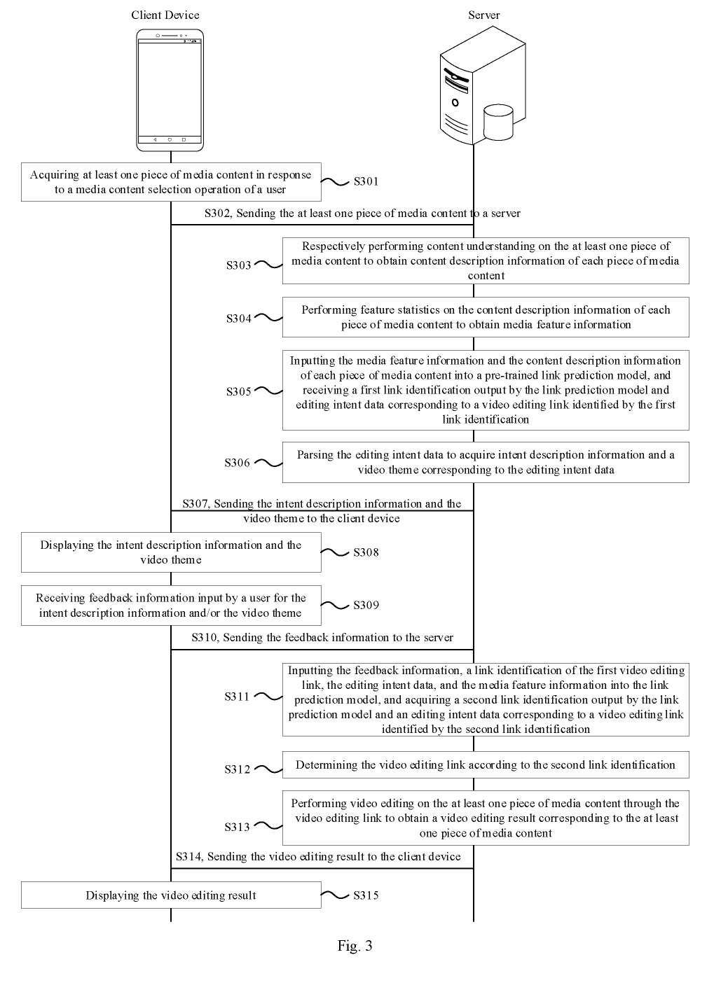

As an extension and refinement of the above embodiments, an embodiment of the present application further provides another video editing method. As shown in FIG. 3, the video editing method includes the following steps:

S301, a client device acquires at least one piece of media content in response to a media content selection operation of a user.

S302, the client device sends the at least one piece of media content to a server.

Correspondingly, the server receives the at least one piece of media content sent by the client device.

S303, the server respectively performs content understanding on the at least one piece of media content to obtain content description information of each piece of media content.

For the specific implementations of the above steps S301 to S303, reference may be made to the above steps S201 to S203, and details are not repeated here to avoid redundancy.

S304, the server performs feature statistics on the content description information of each piece of media content to obtain media feature information.

For the specific implementation of the above step S304, reference may be made to the above step S211, and details are not repeated here to avoid redundancy.

S305, the server inputs the media feature information and the content description information of each piece of media content into a pre-trained link prediction model, and receiving a first link identification output by the link prediction model and editing intent data corresponding to a video editing link identified by the first link identification.

S306, the server parses the editing intent data to acquire intent description information and a video theme corresponding to the editing intent data.

Similarly, the server may parse the editing intent data through an intent understanding model to acquire the intent description information and the video theme corresponding to the editing intent data.

S307, the server sends the intent description information and the video theme to the client device.

Correspondingly, the client device receives the intent description information and the video theme sent by the server.

S308, the client device displays the intent description information and the video theme.

S309, the client device receives feedback information input by a user for the intent description information and/or the video theme.

S310, the client device sends the feedback information to the server.

Correspondingly, the server receives the feedback information sent by the client device.

S311, the server inputs the feedback information, a link identification of the first video editing link, the editing intent data, and the media feature information into the link prediction model, and acquires a second link identification output by the link prediction model and an editing intent data corresponding to a video editing link identified by the second link identification.

Similarly, after the server inputs the feedback information, the link identification of the first video editing link, the editing intent data, and the media feature information into the link prediction model, and acquires the second link identification output by the link prediction model and the editing intent data corresponding to the video editing link identified by the second link identification, the server may further return to step S306 to parse the editing intent data corresponding to the redetermined video editing link, acquire the intent description information and the video theme corresponding to the editing intent data, and send the parsed intent description information and video theme to the client device, until the client device sends confirmation information to the video editing apparatus.

S312, the server determines the video editing link according to the second link identification.

S313, the server performs video editing on the at least one piece of media content through the video editing link to obtain a video editing result corresponding to the at least one piece of media content.

S314, the server sends the video editing result to the client device.

S315, the client device displays the video editing result.

Based on the same inventive concept, as an implementation of the above method, an embodiment of the present application further provides a video editing apparatus. This embodiment corresponds to the foregoing method embodiment. For ease of reading, details in the foregoing method embodiment are not repeated one by one in this embodiment, but it should be clear that the video editing apparatus in this embodiment may correspondingly implement all the contents in the foregoing method embodiment.

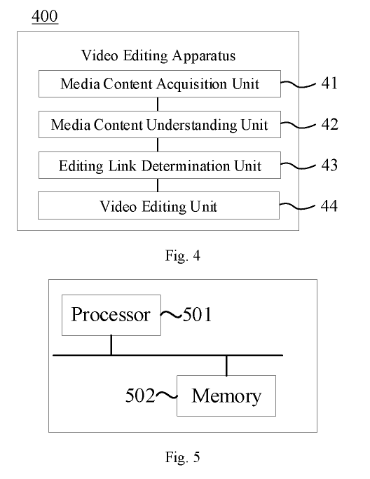

An embodiment of the present application provides a video editing apparatus. FIG. 4 is a schematic structural diagram of the video editing apparatus. As shown in FIG. 4, the video editing apparatus 400 includes:
a media content acquisition unit 41, configured to acquire at least one piece of media content;
a media content understanding unit 42, configured to respectively perform content understanding on the at least one piece of media content to obtain content description information of each piece of media content;
an editing link determination unit 43, configured to determine a video editing link according to the content description information of each piece of media content, where the video editing link includes at least one video editing function and an execution order between each of the at least one video editing function; and
a video editing unit 44, configured to perform video editing on the at least one piece of media content through the video editing link to obtain a video editing result corresponding to the at least one piece of media content.

As an optional implementation of the embodiments of the present application, the editing link determination unit 43 is further configured to acquire an editing intent data according to the content description information of each piece of media content; perform feature statistics on the content description information of each piece of media content to obtain media feature information; and determine the video editing link according to the editing intent data and the media feature information.

As an optional implementation of the embodiments of the present application, the editing link determination unit 43 is further configured to input the content description information of each piece of media content into a pre-trained editing intent prediction model, and acquire an editing intent data output by the editing intent prediction model.

As an optional implementation of the embodiments of the present application, the editing link determination unit 43 is further configured to input the editing intent data and the media feature information into a pre-trained link routing model, and acquire a link identification output by the link routing model; and determine the video editing link according to the link identification.

As an optional implementation of the embodiments of the present application, the editing link determination unit 43 is further configured to, before determining the video editing link according to the editing intent data and the media feature information, acquire intent description information and a video theme corresponding to the editing intent data; display the intent description information and the video theme; receive feedback information input by a user for the intent description information and/or the video theme; and update the editing intent data according to the feedback information.

As an optional implementation of the embodiments of the present application, the editing link determination unit 43 is further configured to input the content description information of each piece of media content, the editing intent data, and the feedback information into the editing intent prediction model, and acquire an updated editing intent data output by the editing intent prediction model.

As an optional implementation of the embodiments of the present application, the editing link determination unit 43 is further configured to perform feature statistics on the content description information of each piece of media content in the set of media content to obtain media feature information; input the media feature information and the content description information of each piece of media content into a pre-trained link prediction model, and receive a first link identification output by the link prediction model; and determine the video editing link according to the first link identification.

As an optional implementation of the embodiments of the present application, the editing link determination unit 43 is further configured to receive an editing intent data corresponding to the video editing link output by the link prediction model; acquire intent description information and a video theme corresponding to the editing intent data; display the intent description information and the video theme; receive feedback information from a user for the intent description information and/or the video theme; and redetermine a video editing link according to the feedback information.

As an optional implementation of the embodiments of the present application, the editing link determination unit 43 is further configured to input the feedback information, the first link identification, the editing intent data, and the media feature information into the link prediction model, and acquire a second link identification output by the link prediction model; and determine the video editing link according to the second link identification.

The video editing apparatus provided by the embodiments of the present application may execute the video editing method provided by any one of the above embodiments, and the implementation principles and technical effects thereof are similar, and details are not repeated here.

Based on the same inventive concept, an embodiment of the present application further provides an electronic device. FIG. 5 is a schematic structural diagram of an electronic device according to an embodiment of the present application. As shown in FIG. 5, the electronic device provided by this embodiment includes: a memory 501 and a processor 502, where the memory 501 is configured to store a computer program, and the processor 502 is configured to, when executing the computer program, execute the video editing method provided by the above embodiments.

Based on the same inventive concept, an embodiment of the present application further provides a computer-readable storage medium storing a computer program, where the computer program, when executed by a processor, causes a computing device to implement the video editing method provided by the above embodiments.

Based on the same inventive concept, an embodiment of the present application further provides a computer program product, where the computer program product, when running on a computer, causes a computing device to implement the video editing method provided by the above embodiments.

Those skilled in the art should understand that, the embodiments of the present application may be provided as a method, system, or computer program product. Therefore, the present application may take the form of an entirely hardware embodiment, an entirely software embodiment, or an embodiment containing both hardware and software elements. Moreover, the present application may take the form of a computer program product implemented on one or more computer-usable storage media having computer-usable program code embodied therein.

The processor may be a central processing unit (Central Processing Unit, CPU), or other general-purpose processor, digital signal processor (Digital Signal Processor, DSP), application specific integrated circuit (Application Specific Integrated Circuit, ASIC), field-programmable gate array (Field-Programmable Gate Array, FPGA) or other programmable logic devices, a discrete gate or transistor logic device, a discrete hardware component, etc. The general-purpose processor may be a microprocessor or any conventional processor, etc.

The memory may include non-permanent memory in a computer-readable medium, random access memory (RAM) and/or non-volatile memory, etc., such as read-only memory (ROM) or flash memory (flash RAM). The memory is an example of a computer-readable medium.

The computer-readable medium includes permanent and non-permanent, removable and non-removable storage media. The storage medium may realize information storage by any method or technology, and the information may be computer-readable instructions, data structures, modules of a program or other data. Examples of the computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, a disk storage or other magnetic storage devices, or any other non-transmission media that may be used to store information that may be accessed by a computing device. According to the definition herein, the computer-readable medium does not include transitory media, such as modulated data signals and carrier waves.

Finally, it should be noted that the above embodiments are only used to illustrate the technical solutions of the present application, rather than limiting them. Although the present application has been described in detail with reference to the foregoing embodiments, those of ordinary skill in the art should understand that they may still modify the technical solutions recited in the foregoing embodiments, or equivalently replace some or all of the technical features. And these modifications or substitutions do not make the essence of the corresponding technical solutions depart from the scope of the technical solutions of the embodiments of the present application.

An embodiment of the present application provides a video editing method, including:
acquiring at least one piece of media content;
respectively performing content understanding on the at least one piece of media content to obtain content description information of each piece of media content;
determining a video editing link according to the content description information of each piece of media content, where the video editing link includes at least one video editing function and an execution order between each of the at least one video editing function; and
performing video editing on the at least one piece of media content through the video editing link to obtain a video editing result corresponding to the at least one piece of media content.

As an optional implementation of the embodiments of the present application, the determining a video editing link according to the content description information of each piece of media content includes:
acquiring editing intent data according to the content description information of each piece of media content;
performing feature statistics on the content description information of each piece of media content to obtain media feature information; and
determining the video editing link according to the editing intent data and the media feature information.

As an optional implementation of the embodiments of the present application, the determining the video editing link according to the editing intent data and the media feature information includes:
inputting the editing intent data and the media feature information into a pre-trained link routing model, and acquiring a link identification output by the link routing model; and
determining the video editing link according to the link identification.

As an optional implementation of the embodiments of the present application, before the determining the video editing link according to the editing intent data and the media feature information, the method further includes:
acquiring intent description information and a video theme corresponding to the editing intent data;
displaying the intent description information and the video theme;
receiving feedback information input by a user for the intent description information and/or the video theme; and
updating the editing intent data according to the feedback information.

As an optional implementation of the embodiments of the present application, the updating the editing intent data according to the feedback information includes:
inputting the content description information of each piece of media content, the editing intent data, and the feedback information into the editing intent prediction model, and acquiring updated editing intent data output by the editing intent prediction model;
performing feature statistics on the content description information of each piece of media content in the set of media content to obtain media feature information;
inputting the media feature information and the content description information of each piece of media content into a pre-trained link prediction model, and receiving a first link identification output by the link prediction model; and
determining the video editing link according to the first link identification.

As an optional implementation of the embodiments of the present application, the method further includes:
receiving editing intent data corresponding to the video editing link output by the link prediction model;
acquiring intent description information and a video theme corresponding to the editing intent data;
displaying the intent description information and the video theme;
receiving feedback information from a user for the intent description information and/or the video theme; and
redetermining a video editing link according to the feedback information.

As an optional implementation of the embodiments of the present application, the redetermining a video editing link according to the feedback information includes:
inputting the feedback information, the first link identification, the editing intent data, and the media feature information into the link prediction model, and acquiring a second link identification output by the link prediction model; and
determining the video editing link according to the second link identification.
An embodiment of the present application provides a video editing apparatus, including:
a media content acquisition unit, configured to acquire at least one piece of media content;
a media content understanding unit, configured to respectively perform content understanding on the at least one piece of media content to obtain content description information of each piece of media content;
an editing link determination unit, configured to determine a video editing link according to the content description information of each piece of media content, where the video editing link includes at least one video editing function and an execution order between each of the at least one video editing function; and
a video editing unit, configured to perform video editing on the at least one piece of media content through the video editing link to obtain a video editing result corresponding to the at least one piece of media content.

As an optional implementation of the embodiments of the present application, the editing link determination unit is further configured to acquire editing intent data according to the content description information of each piece of media content; perform feature statistics on the content description information of each piece of media content to obtain media feature information; and
determine the video editing link according to the editing intent data and the media feature information.

As an optional implementation of the embodiments of the present application, the editing link determination unit is further configured to input the content description information of each piece of media content into a pre-trained editing intent prediction model, and acquire editing intent data output by the editing intent prediction model.

As an optional implementation of the embodiments of the present application, the editing link determination unit is further configured to input the editing intent data and the media feature information into a pre-trained link routing model, and acquire a link identification output by the link routing model; and
determine the video editing link according to the link identification.

As an optional implementation of the embodiments of the present application, the editing link determination unit is further configured to, before determining the video editing link according to the editing intent data and the media feature information, acquire intent description information and a video theme corresponding to the editing intent data; display the intent description information and the video theme; receive feedback information input by a user for the intent description information and/or the video theme; and update the editing intent data according to the feedback information.

As an optional implementation of the embodiments of the present application, the editing link determination unit is further configured to input the content description information of each piece of media content, the editing intent data, and the feedback information into the editing intent prediction model, and acquire updated editing intent data output by the editing intent prediction model.

As an optional implementation of the embodiments of the present application, the editing link determination unit is further configured to perform feature statistics on the content description information of each piece of media content in the set of media content to obtain media feature information; input the media feature information and the content description information of each piece of media content into a pre-trained link prediction model, and receive a first link identification output by the link prediction model; and determine the video editing link according to the first link identification.

As an optional implementation of the embodiments of the present application, the editing link determination unit is further configured to receive editing intent data corresponding to the video editing link output by the link prediction model; acquire intent description information and a video theme corresponding to the editing intent data; display the intent description information and the video theme; receive feedback information from a user for the intent description information and/or the video theme; and redetermine a video editing link according to the feedback information.

As an optional implementation of the embodiments of the present application, the editing link determination unit is further configured to input the feedback information, the first link identification, the editing intent data, and the media feature information into the link prediction model, and acquire a second link identification output by the link prediction model; and determine the video editing link according to the second link identification.

An embodiment of the present application provides an electronic device, including: a memory and a processor, where the memory is configured to store a computer program, and the processor is configured to, when executing the computer program, cause the electronic device to implement the video editing method according to any one of the above implementations.

An embodiment of the present application provides a computer-readable storage medium storing a computer program, where the computer program, when executed by a computing device, causes the computing device to implement the video editing method according to any one of the above implementations.

An embodiment of the present application provides a computer program product, where the computer program product, when running on a computer, causes the computer to implement the video editing method according to any one of the above implementations.

1. A video editing method, comprising:
acquiring at least one piece of media content;
respectively performing content understanding on the at least one piece of media content to obtain content description information of each piece of media content;
determining a video editing link based on the content description information of each piece of media content, wherein the video editing link comprises at least one video editing function and an execution order between each of the at least one video editing function; and
performing video editing on the at least one piece of media content through the video editing link to obtain a video editing result corresponding to the at least one piece of media content.

2. The method of claim 1, wherein the determining a video editing link based on the content description information of each piece of media content comprises:
acquiring editing intent data based on the content description information of each piece of media content;
performing feature statistics on the content description information of each piece of media content to obtain media feature; and
determining the video editing link based on the editing intent data and the media feature.

3. The method of claim 2, wherein the determining a video editing link based on the content description information of each piece of media content comprises:
inputting the content description information of each piece of media content into an editing intent prediction model, and acquiring the editing intent data output by the editing intent prediction model.

4. The method of claim 2, wherein the determining the video editing link based on the editing intent data and the media feature comprises:
inputting the editing intent data and the media feature into a link routing model, and acquiring a link identification output by the link routing model; and
determining the video editing link based on the link identification.

5. The method of claim 3, further comprising:
acquiring intent description information corresponding to the editing intent data and a video theme corresponding to the editing intent data;
displaying the intent description information and the video theme;
receiving feedback input by a user for at least one selected from a group consisting of the intent description information and the video theme; and
updating the editing intent data based on the feedback.

6. The method of claim 5, wherein the updating the editing intent data based on the feedback comprises:
inputting the content description information of each piece of media content, the editing intent data, and the feedback into the editing intent prediction model, and acquiring updated editing intent data output by the editing intent prediction model.

7. The method of claim 1, wherein the determining a video editing link based on the content description information of each piece of media content comprises:
performing feature statistics on the content description information of each piece of media content in the set of media content to obtain media feature;
inputting the media feature and the content description information of each piece of media content into a link prediction model, and receiving a first link identification output by the link prediction model; and
determining the video editing link based on the first link identification.

8. The method of claim 7, further comprising:
receiving editing intent data corresponding to the video editing link output by the link prediction model;
acquiring intent description information corresponding to the editing intent data and a video theme corresponding to the editing intent data;
displaying the intent description information and the video theme;
receiving feedback from a user for at least one selected from a group consisting of the intent description information and the video theme; and
redetermining a video editing link based on the feedback.

9. The method of claim 8, wherein the redetermining a video editing link based on the feedback comprises:
inputting the feedback, the first link identification, the editing intent data, and the media feature into the link prediction model, and acquiring a second link identification output by the link prediction model; and
determining the video editing link based on the second link identification.

10. An electronic device, comprising:
at least a processor, and
a non-transitory memory with instructions thereon,
wherein the instructions upon execution by the processor, cause the processor to:
acquire at least one piece of media content;
respectively perform content understanding on the at least one piece of media content to obtain content description information of each piece of media content;
determine a video editing link based on the content description information of each piece of media content, wherein the video editing link comprises at least one video editing function and an execution order between each of the at least one video editing function; and
perform video editing on the at least one piece of media content through the video editing link to obtain a video editing result corresponding to the at least one piece of media content.

11. The electronic device of claim 10, wherein when determining the video editing link based on the content description information of each piece of media content, the processor is further caused to:
acquire editing intent data based on the content description information of each piece of media content;
perform feature statistics on the content description information of each piece of media content to obtain media feature; and
determine the video editing link based on the editing intent data and the media feature.

12. The electronic device of claim 11, wherein when determining the video editing link based on the content description information of each piece of media content, the processor is further caused to:
input the content description information of each piece of media content into an editing intent prediction model, and acquire the editing intent data output by the editing intent prediction model.

13. The electronic device of claim 11, wherein when determining the video editing link based on the editing intent data and the media feature, the processor is further caused to:
input the editing intent data and the media feature into a link routing model, and acquire a link identification output by the link routing model; and
determine the video editing link based on the link identification.

14. The electronic device of claim 12, wherein the processor is further caused to:
acquire intent description information corresponding to the editing intent data and a video theme corresponding to the editing intent data;
display the intent description information and the video theme;
receive feedback input by a user for at least one selected from a group consisting of the intent description information and the video theme; and
update the editing intent data based on the feedback.

15. The electronic device of claim 14, wherein when updating the editing intent data based on the feedback, the processor is further caused to:
input the content description information of each piece of media content, the editing intent data, and the feedback into the editing intent prediction model, and acquiring updated editing intent data output by the editing intent prediction model.

16. The electronic device of claim 10, wherein when determining the video editing link based on the content description information of each piece of media content, the processor is further caused to:
perform feature statistics on the content description information of each piece of media content in the set of media content to obtain media feature;
input the media feature and the content description information of each piece of media content into a link prediction model, and receive a first link identification output by the link prediction model; and
determine the video editing link based on the first link identification.

17. The electronic device of claim 16, wherein the processor is further caused to:
receive editing intent data corresponding to the video editing link output by the link prediction model;
acquire intent description information corresponding to the editing intent data and a video theme corresponding to the editing intent data;
display the intent description information and the video theme;
receive feedback from a user for at least one selected from a group consisting of the intent description information and the video theme; and
redetermine a video editing link based on the feedback.

18. A non-transitory computer-readable storage medium storing instructions that cause at least a processor to:
acquire at least one piece of media content;
respectively perform content understanding on the at least one piece of media content to obtain content description information of each piece of media content;
determine a video editing link based on the content description information of each piece of media content, wherein the video editing link comprises at least one video editing function and an execution order between each of the at least one video editing function; and
perform video editing on the at least one piece of media content through the video editing link to obtain a video editing result corresponding to the at least one piece of media content.

19. The non-transitory computer-readable storage medium of claim 18, wherein when determining the video editing link based on the content description information of each piece of media content, the processor is further caused to:
acquire editing intent data based on the content description information of each piece of media content;
perform feature statistics on the content description information of each piece of media content to obtain media feature; and
determine the video editing link based on the editing intent data and the media feature.

20. The non-transitory computer-readable storage medium of claim 18, wherein when determining the video editing link based on the content description information of each piece of media content, the processor is further caused to:
perform feature statistics on the content description information of each piece of media content in the set of media content to obtain media feature;
input the media feature and the content description information of each piece of media content into a link prediction model, and receive a first link identification output by the link prediction model; and
determine the video editing link based on the first link identification.
